(19) United States
(12) Patent Application Publication
(10) Pub. No.: US 2008/0306868 A1
(43) Pub. Date: Dec. 11, 2008

(54) Unlimited toll utilization

(75) Inventors: Benjamin P. Robinson, Plano, TX (US); Sarath K. Balachandran, Irving, TX (US)

Correspondence Address: WINSTEAD PC, P.O. BOX 50784, DALLAS, TX, 75201, US

(73) Assignee: Rent-A-Toll, Ltd., Plano, TX (US)

(21) Appl. No.: 11/810,751

(22) Filed: Jun. 7, 2007

(51) Int. Cl. G06Q 40/00

(52) U.S. Cl. 705/40

(57) ABSTRACT

A system, method, and computer readable medium for unlimited toll utilization by a transport in a fleet comprises receiving, by a toll rental entity, fleet information from a third party entity, receiving, by a toll authority, the fleet information from the toll rental entity, receiving, by the toll authority, toll usage information, matching, by the toll authority, the toll usage information with the fleet information, receiving, by the toll rental entity, the matched information, matching, by the toll rental entity, the matched information with a fleet subscription account, paying a fee, by the toll rental entity to the toll authority, based on the matched information with the fleet subscription account, and billing, by the toll rental entity, the third party entity, a fixed fee for each transport in the fleet, wherein the fixed fee is related to the paid fee.

### CROSS REFERENCE TO RELATED APPLICATIONS

The present patent application is related to U.S. Provisional Patent Application No. 60/757,347, titled Electronic Toll Payment System And Method For Third Party Operated Vehicles Utilizing An Onboard Unit, filed on Jan. 9, 2006, U.S. Provisional Patent Application No. 60/757,405, titled GPS Toll System And Method For Collection Of Rental Vehicle Tolls, filed on Jan. 9, 2006, U.S. Provisional Patent Application No. 60/726,300, titled Toll Fee System And Method Using Prepaid Toll Pass, filed on Oct. 13, 2005, U.S. Provisional Patent Application No. 60/759,937, titled Business Process For Toll Fee System And Method For Vehicle Registration, Invoicing, Opt-In Services, And Toll Violations, filed on Jan. 18, 2006, U.S. Provisional Patent Application No. 60/763,097 titled Method And System For Toll Collection With Optional Service Capabilities, filed on Jan. 27, 2006, U.S. Non-Provisional patent application Ser. No. 11/125,521, titled Toll Fee System And Method, filed on May 10, 2005, to U.S. Non-Provisional Patent Application Docket No. RTL008, titled System, Method, And Computer Readable Medium For Billing, filed on Sep. 6, 2006, to U.S. Non-Provisional Patent Application Docket No. RTL009, titled System, Method, And Computer Readable Medium For Billing Tolls, filed on Sep. 6, 2006, to U.S. Non-Provisional Patent Application Docket No. RTL010, titled System, Method And Computer Readable Medium For Toll Service Activation And Billing, filed on Oct. 13, 2006, to U.S. Non-Provisional Patent Application Docket No. RTL010A, titled System, Method And Computer Readable Medium For Billing Based On A Duration Of A Service Period, filed on Oct. 13, 2006, to U.S. Non-Provisional Patent Application Docket No. RTL030, tilted Paying Tolls Utilizing A Financial Service Provider And Paying A Subscription Or License Fee, filed on Dec. 18, 2006, to U.S. Non-Provisional Patent Application Docket No. RTL030A, titled Transferring Toll Data From A Third Party Operated Transport To A User Account, filed on Dec. 18, 2006, to U.S. Provisional Patent Application No. 60/757,406, titled Online Travel Provider Toll System And Method, filed on Jan. 9, 2006, and to U.S. Non-Provisional patent application Ser. No. 11/651,414 titled Billing A Toll Service Via A Travel Service Provider For Use Of A Third Party Entity Transport, filed on Jan. 9, 2007, the entire contents of each of which are incorporated by reference herein.

### BACKGROUND OF THE INVENTION

The present disclosure is generally related to toll billing and, more specifically, to a method, system, and computer readable medium for unlimited toll utilization.

A toll road is a road on which a toll authority collects a fee for use of the toll road. There are an increasing number of toll roads having different toll payment systems. For example, some systems use a radio transponder mounted in or on a customer's vehicle to deduct toll fares from a pre-paid account as the vehicle passes through a toll barrier. This reduces manpower at tollbooths and increases traffic flow and fuel efficiency by reducing the need for vehicles to make complete stops to pay tolls.

Various problems and limitations exist with respect to current toll billing models especially for vehicles that are a part of a fleet. Such a fleet may number hundreds or thousands of vehicles and fleet owners do not currently have an ability to exert control over an amount of billing and how that billing is incurred by the fleet as a whole. As such, what is needed is a method, system, and computer readable medium that overcomes these problems and limitations.

### SUMMARY OF THE INVENTION

The present invention includes a number of entities such as a Third Party Entity (TPE), a Toll Rental Entity (TRE), and a Toll Authority (TA) that will be described below.

Third Party Entity (TPE)—The TPE is typically the rental car agency, however in some circumstances it could be a user of a rental agency vehicle or a fleet vehicle for a university, a trucking company or another fleet vehicle entity.

Toll Rental Entity (TRE)—The TRE is typically a provider of toll rental services to a third party operated vehicle renter, however in some circumstances it could be a provider of toll rental services to a vehicle owner, to the TPE, and to the TA.

Toll Authority (TA)—Toll authorities are government, quasi-government or private entities that are legally authorized to collect tolls. These entities are required by law to use the collected tolls to build and maintain the roads for which the tolls are collected.

The present invention allows a TRE to charge a flat subscription price to utilize toll services for fleet vehicles. A single price is charged per vehicle in the fleet and will cover any and all tolls accumulated for that vehicle during a period of time.

In one embodiment of the disclosure, a method for unlimited toll utilization by a transport in a fleet comprises receiving, by a toll rental entity, fleet information from a third party entity, receiving, by a toll authority, the fleet information from the toll rental entity, receiving, by the toll authority, toll usage information, matching, by the toll authority, the toll usage information with the fleet information, receiving, by the toll rental entity, the matched information, matching, by the toll rental entity, the matched information with a fleet subscription account, paying a fee, by the toll rental entity to the toll authority, based on the matched information with the fleet subscription account, and billing, by the toll rental entity, the third party entity, a fixed fee for each transport in the fleet, wherein the fixed fee is related to the paid fee.

In another embodiment of the disclosure, a computer readable medium comprises instructions for billing, by a toll rental entity, a fixed fee for unlimited toll usage by a transport, based on at least one of: a transport toll volume and a toll transaction volume.

In a further embodiment of the disclosure, a system for billing unlimited toll utilization comprises at least one third party entity, and a toll rental entity communicably coupled to the third party entity, wherein the toll rental entity bills the third party entity a based on at least one of: a number of transports in a fleet, a number of transactions by the transports in the fleet; and a fixed fee.

### BRIEF DESCRIPTION OF THE DRAWINGS

FIG. 1 illustrates a first flow chart for unlimited toll utilization according to an embodiment of the disclosure;

FIG. 2 illustrates an invoicing model according to an embodiment of the disclosure;

FIG. 3 illustrates a second flow chart for unlimited toll utilization according to an embodiment of the disclosure;

FIG. 4 illustrates a third flow chart for unlimited toll utilization according to an embodiment of the disclosure; and

FIG. 5 illustrates a system for unlimited toll utilization according to an embodiment of the disclosure.

### DETAILED DESCRIPTION OF THE INVENTION

The present invention provides a TRE with an ability to charge a flat price (that can be subscription based) to utilize toll services for fleet transports (which include vehicles, buses, motorcycles, trains, planes, boats, and the like). A single price is charged per vehicle in the fleet and will cover any and all tolls accumulated for that vehicle during a period of time. Such a period of time is typically a monthly based subscription, however the subscription could be hourly, daily, weekly, quarterly, annually, or any other time period. The charge is based on at least one of: fleet size and toll facility usage rates. Higher utilization rates will require a higher subscription price to be charged. The subscription rate would be charged whether or not a vehicle utilized tolls during any given day/period and the rate provides unlimited toll road coverage to a specific vehicle(s) for a certain period of time.

According to the present invention, all toll costs are included in the simple fee. For example, a vehicle may be rented for 30 days during a month. The subscription model would charge a daily (or weekly) fee for that vehicle and every other vehicle in the fleet. The vehicle may only use tolls on 10 days of the month (33% utilization rate), however the vehicle fleet owner will pay the fee for all 30 days in the month. In this model, the pricing of the service to the vehicle user/renter is left to the discretion of the fleet vehicle owner who may charge a daily amount (such as $5 per day) or who may include the service for free for any vehicle of a certain class (such as for vehicles of a premium class). The fleet vehicle owner is only responsible to pay the TRE the simple fee for the particular period of time. The TRE will register that vehicle with the TA and guarantee payment for every toll fee encountered for that vehicle. This model leaves discretionary pricing to the fleet vehicle owner and minimizes the daily costs to any given driver. In certain situations, some drivers or vehicles may pay a fee for the service even though they did not use any tolls.

The present invention has several benefits because it spreads the cost of tolls over every vehicle and every rental contract. Thus, the direct cost to a customer who uses tolls is minimal (for example, $0.25 to $1.50 per day). Other models only charge for users that utilize a toll service with costs ranging from $1.50 or more per day plus tolls to fixed rate charges of $8.95 or more per day. Although there is a cost to every vehicle renter with the present invention, a fleet owner has the ability to not pass the cost on to every driver of a vehicle belonging to the fleet and only charge renters who actually use the service. Pricing is flexible for the fleet vehicle owner based on how they want to provide the service and benefits to their customers.

The benefit of the present invention to the TA is that every toll is guaranteed. The benefit to the TPE is the flexibility in how they price the service and that they will never encounter a single violation for any customer (in markets where it is offered). The benefit to the renter is the low cost that is assigned to utilize the service. In addition, all billing for the service can be included in a rental contract between the customer and the TPE or between two or more of the entities or customers/renters described above. Renters can also receive express lane access at a minimal cost. The service provides more flexibility to the fleet vehicle owner and eliminates all violation costs to the fleet vehicle owner, thereby driving down operational costs to collect on violators.

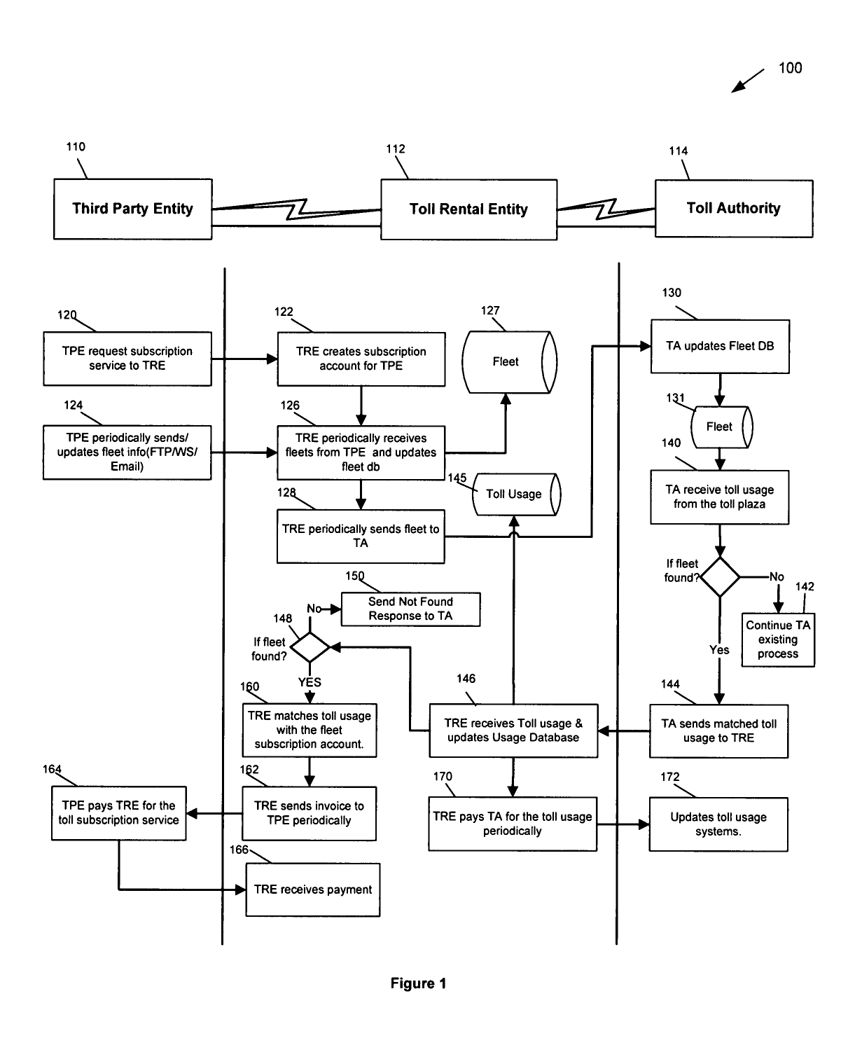

Referring now to FIG. 1, a first flow chart 100 of the present invention includes a TPE 110, a TRE 112, and a TA 114. One or more of the functions or steps described below may be performed by one or more of these entities 110-114 and more than one of these entities may be utilized with the present invention. The Third Party Entity 110 requests toll subscription service to the Toll Rental Entity 112, which creates a subscription account for third party entity 122. The Third Party Entity 110 periodically sends the fleet information to the Toll Rental Entity, for example, via File Transfer Protocol, web services, email, or other mechanism 124. The Third Party Entity 110 might choose their own communication protocol to send or receive fleet information. Depending upon the underling fleet identification method some additional information might be sent from Third Party Entity 110. For example, the TPE 110 might send license plate and state information if a license plate reader mechanism is used or the TPE might send vehicle information (utilizing GPS, RFID, or other mechanism) to the TPE.

The Toll Rental Entity 112 updates a fleet database 127 with the received information from the Third Party Entity at step 126. The Toll Rental Entity 112 sends fleet information to the Toll Authority at step 128. The TRE can use various protocols to transfer the information to the Toll Authority 114 which updates the fleet database 130 whenever it receives the update from Toll Rental Entity. When a third party vehicle renter uses a toll road, the Toll Authority 114 receives the toll usage information from the toll plaza or toll lane 140, based on a vehicle identification method, the TA 114 checks the vehicle in a fleet database 131 based on a vehicle identifier, and if the vehicle information is not found in the fleet database at the TA, then the TA continues with their existing process of handling such a situation. If the Toll Authority 114 finds the vehicles in the database, then the TA sends the matched toll usage to the toll rental entity with vehicle information and/or with toll usage information such as time stamp, location, charge, and the like 142. The TRE 112 updates the received toll usage from the TA 114 in the toll usage database 144 and pays the TA for the toll usage immediately or periodically 160. The Toll Rental Entity 112 checks 148 if the vehicle is in the database. If the vehicle is not found, the TRE sends the response back to the Toll Authority at step 150. If the vehicle is found in the database, the Toll Rental Entity 112 sends the toll usage to the TPE 110 periodically 162. The Toll Rental Entity 112 receives payment from the TPE 110 periodically for the toll subscription service 164. The transfer of information occurs via at least one of: a wireless protocol, a wired protocol and a combination of the wireless protocol and the wired protocol. The information may be sent via at least one of: text, data, voice, and video. The steps in the flow chart are performed by software, hardware, firmware, and/or the combination of software, hardware, and/or firmware.

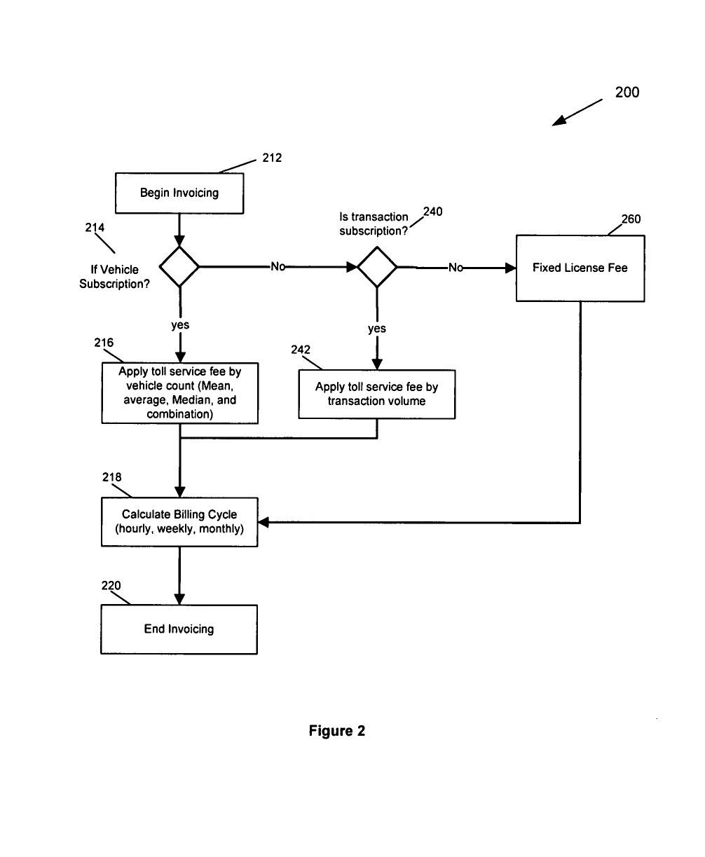

Referring now to FIG. 2, a second flow chart 200 of the present invention is depicted. A TPE can be invoiced 212 based on at least one of: vehicle subscription, transaction subscription and fixed fee. In the vehicle subscription model 214 is used, the TPE pays a TRE by vehicle count 216 based on a calculated billing period 218. In the transaction subscription model 240, the TPE pays the TRE by a number of transactions 242. In the third model, the TPE pays the TRE a fixed fee 260 for a billing period or any other period which may be measured in terms of hours, days, weeks, months or years 218. The transfer of information occurs via at least one of: a wireless protocol, a wired protocol and a combination of the wireless protocol and the wired protocol. The information may be sent via at least one of: text, data, voice, and video. The steps in the flow are performed by software, hardware, firmware, and/or the combination of software, hardware, and/or firmware.

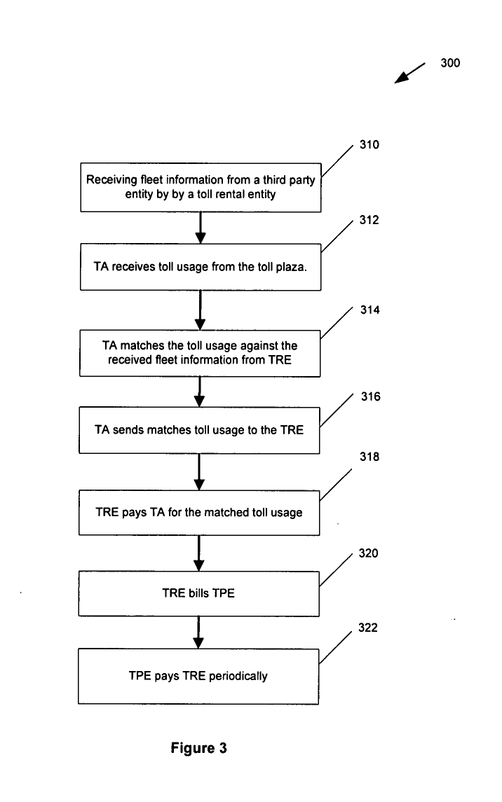

Referring now to FIG. 3, a flow chart 300 describing a method for unlimited toll utilization by a transport in a fleet of the present invention is depicted. A TRE receives fleet information from a TPE 310. A TA receives the toll usage from a toll plaza or toll lanes if the renter uses a toll road 312. The TA matches toll usage against received fleet information from the TRE 314 and the TA sends the matched toll usage to the TRE 316. The TRE pays the TA for the matched toll usage 318 and bills the TPE for the toll service 320. The TPE pays the TRE periodically (or in some other timeframe) 322.

In the method of the present invention, the fixed fee may be fixed across all markets, or may vary based on at least one of: a location of each of the transports in the fleet, a number of transports in the fleet, a length of use of each transport in the fleet, a time of day of the use of each transport in the fleet, a length of a contract for each transport in the fleet, a toll usage of each of the transports in the fleet, a day of the use of each transport in the fleet, a week of the use of each transport in the fleet, a month of the use of each transport in the fleet, a year of the use of each transport in the fleet, an age of each of the transports in the fleet, an emissions rate of each of the transports in the fleet, an emissions output of each of the transports in the fleet, and an average mile per gallon rating of each of the transports in the fleet. The fixed fee is sent once per period and covers an unlimited number of toll transactions for the period, wherein the period is at least one of: a second, a minute, an hour, a day, a week, a month and a year.

In the method of the present invention, the number of toll transaction is at least one of: zero toll transactions and one or more toll transactions, wherein if the toll usage information is not matched to the fleet information, sending a violation by the toll authority, wherein the receiving occurs in at least one of: real time, near real time and periodically, wherein the fleet information for each transport includes at least one of: an owner of the transport, a license plate number of the transport, a vehicle identification number of the transport, a type of the transport, a color of the transport, a manufacturer of the transport, a year of manufacture of the transport and a condition of the transport. The transfer of information in the method occurs via at least one of: a wireless protocol, a wired protocol and a combination of the wireless protocol and the wired protocol. The information may be sent via at least one of: text, data, voice, and video. The steps in the flow are performed by software, hardware, firmware, and/or the combination of software, hardware, and/or firmware.

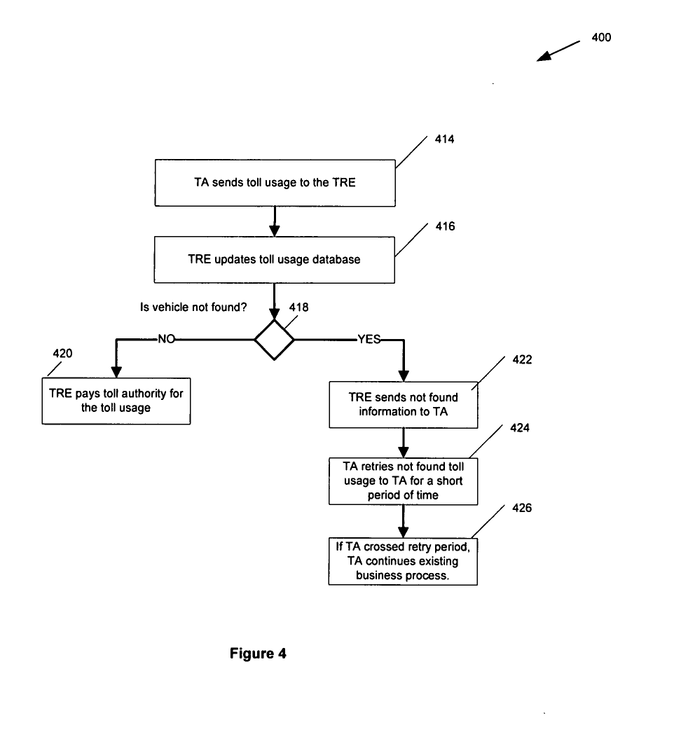

Referring now to FIG. 4, a flow chart describing unfound toll usage 400 is depicted. The Toll Authority sends the matched toll usage to the TRE at step 414 which updates a toll usage database at step 416. The TRE attempts to match the toll usage with the fleet database at step 418. If the fleet does not matches the toll usage then toll rental entity sends the unmatched or unfound information to the TA at step 422 which retries the unmatched toll usage for a specific number of retries for a short period of time (for example, 15 days) 424. This helps the TRE to receive any pending fleet updates from the TPE if there is any communication delay. The TA stops sending the unmatched toll usage information if the number of retry exceeds the planned/agreed interval or the TPE matches the information with the fleet, and the TA continues with its existing processes at step 426. The transfer of information occurs via at least one of: a wireless protocol, a wired protocol and a combination of the wireless protocol and the wired protocol. The information may be sent via at least one of: text, data, voice, and video. The steps in the flow are performed by software, hardware, firmware, and/or the combination of software, hardware, and/or firmware.

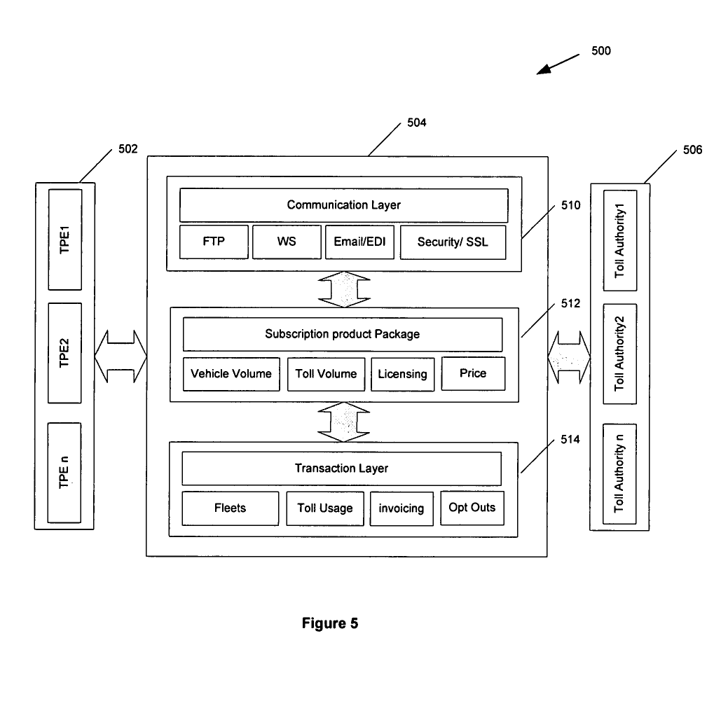

Referring now to FIG. 5, a system or architecture 500 of the present invention is depicted. The system or architecture 500, which is preferably a part of a TRE 504 or under the full or partial control of the TRE, depicts various communications components. A communication layer 510 implements communication channels such as File Transfer Protocol, web services, EDI, email including a security mechanism such as Secure Socket Layer to send and receive information between the TPE 502, the TA 506 and/or another entity (not shown). A subscription product package layer 512 offers volume subscriptions, transaction subscriptions fixed fee subscriptions and licensing. Fleet transactions, toll usage transactions, invoicing transactions and opt-out transactions are implemented under a transaction layer 514. The TPE 502 and the TA 506 communicate via the communication layer 510. The transfer of information occurs via at least one of: a wireless protocol, a wired protocol and a combination of the wireless protocol and the wired protocol. The information may be sent via at least one of: text, data, voice, and video. The steps in the flow are performed by software, hardware, firmware, and/or the combination of software, hardware, and/or firmware.

In another embodiment of the present invention, a computer readable medium (or software running or able to be run on at least one of the entities described above) comprises instructions for billing, by a toll rental entity, a fixed fee for unlimited toll usage by a transport, based on at least one of: a transport toll volume and a toll transaction volume, wherein each transport is at least one of: an independently owned transport and a transport in a fleet. The computer readable medium comprises instructions for receiving, by the toll rental entity, toll usage information and transport information, comprises instructions for matching, by the toll rental entity, the received information with a transport subscription account, comprising instructions for billing the fixed fee amount based on the matching, comprising instructions for billing the fixed fee to at least one of: a third party entity and a toll authority, wherein the fixed fee may vary based on at least one of: a location of each of the transports in the fleet, a number of transports in the fleet, a length of use of each transport in the fleet, a time of day of the use of each transport in the fleet, a day of the use of each transport in the fleet, a week of the use of each transport in the fleet, a month of the use of each transport in the fleet, a year of the use of each transport in the fleet, a length of a contract for each transport in the fleet, a toll usage of each of the transports in the fleet, an age of each of the transports in the fleet, an emissions rate of each of the transports in the fleet, an emissions output of each of the transports in the fleet and an average mile per gallon rating of each of the transports in the fleet.

In a further embodiment of the present invention, a system for billing unlimited toll utilization comprises at least one third party entity and a toll rental entity communicably coupled to the third party entity, wherein the toll rental entity bills the third party entity a based on at least one of: a number of transports in a fleet, a number of transactions by the transports in the fleet and a fixed fee, wherein the toll rental entity bills based on an alternating fixed fee, wherein, if the toll rental entity bills based on a number of transports in a fleet, the toll rental entity bills based on at least one of: a mean of a size of a fleet and a median of the size of the fleet, wherein, if the toll rental entity bills based on a number of transactions by the transports in the fleet, the toll rental entity bills based on a transaction volume, wherein the toll rental entity bills the third party entity a based on at least one of: a second, a minute, an hour, a day, a week, a month and a year.

The present invention allows for fixed rate pricing to be charged to fleet vehicle owners for every subscribed or registered vehicle (or for a portion of vehicles). The present processes monthly fees to the vehicle fleet owner and allows the vehicle fleet owner to control and influence pricing. The present invention can also track violators for the fleet vehicle owner. Their payment to the toll service provider will be a fixed fee based on at least one of: the market location, the location of vehicles, and the usage rates of tolls in the system by renters. The present invention will identify which contracts selected the service and which “opt-outs” used tolls without proper authorization through their rental contract. In one embodiment, the current invention charges every vehicle renter regardless of whether they used a toll road. In this manner, the cost for toll users is dramatically lowered. The cost is spread across every vehicle in the fleet and thus the cost to the rental company is minimal. The rental company then has the option to price the service to customers at a very low daily rate. This will help to drive new renters to access toll roads and reduce congestion within the region. The rental agency has flexibility to give the service away to its premium users, charge a flat daily rate or even roll the cost directly into the price of the vehicle and provide the renter with unlimited access to toll road usage. A toll service provider charges a flat fee per vehicle per day and then pays all tolls for that related vehicle when incurred. Future applications can be applied on a national level with or without a rental car. It could be packaged as a service with every new vehicle in the form of a government tax based on where the vehicle was purchased.

Although an exemplary embodiment of the system of the embodiment of the disclosure has been illustrated in the accompanied drawings and described in the foregoing detailed description, it will be understood that the embodiment of the disclosure is not limited to the embodiments disclosed, but is capable of numerous rearrangements, modifications, and substitutions without departing from the spirit of the embodiment of the disclosure as set forth and defined by the following claims. For example, the capabilities of the embodiment of the disclosure can be performed fully and/or partially by one or more of the entities. Also, these capabilities may be performed in the current manner or in a distributed manner and on, or via, any device able to provide and/or receive information. Further, although depicted in a particular manner, various modules or blocks may be repositioned without departing from the scope of the current embodiment of the disclosure. Still further, although depicted in a particular manner, a greater or lesser number of modules and connections can be utilized with the embodiment of the disclosure in order to accomplish the embodiment of the disclosure, to provide additional known features to the embodiment of the disclosure, and/or to make the embodiment of the disclosure more efficient. Also, the information sent between various modules can be sent between the modules via at least one of a data network, the Internet, an Internet Protocol network, a wireless source, and a wired source and via plurality of protocols.

What is claimed is:

1. A method for unlimited toll utilization by a transport in a fleet, comprising:
receiving, by a toll rental entity, fleet information from a third party entity;
receiving, by a toll authority, the fleet information from the toll rental entity;
receiving, by the toll authority, toll usage information;
matching, by the toll authority, the toll usage information with the fleet information;
receiving, by the toll rental entity, the matched information;
matching, by the toll rental entity, the matched information with a fleet subscription account;
paying a fee, by the toll rental entity to the toll authority, based on the matched information with the fleet subscription account; and
billing, by the toll rental entity, the third party entity, a fixed fee for each transport in the fleet, wherein the fixed fee is related to the paid fee.

2. The method of claim 1, wherein the fixed fee is fixed across all markets.

3. The method of claim 1, wherein the fixed fee may vary based on at least one of:
a location of each of the transports in the fleet;
a number of transports in the fleet;
a length of use of each transport in the fleet;
a time of day of the use of each transport in the fleet;
a length of a contract for each transport in the fleet;
a toll usage of each of the transports in the fleet;
a day of the use of each transport in the fleet;
a week of the use of each transport in the fleet;
a month of the use of each transport in the fleet;
a year of the use of each transport in the fleet;
an age of each of the transports in the fleet;
an emissions rate of each of the transports in the fleet;
an emissions output of each of the transports in the fleet; and
an average mile per gallon rating of each of the transports in the fleet.

4. The method of claim 1, wherein the fixed fee is sent once per period and covers an unlimited number of toll transactions for the period.

5. The method of claim 1, wherein the period is at least one of:
a second;
a minute;
an hour;
a day;
a week;
a month; and
a year.

6. The method of claim 1, wherein the number of toll transaction is at least one of:
zero toll transactions; and
one or more toll transactions.

7. The method of claim 1, wherein if the toll usage information is not matched to the fleet information, sending a violation by the toll authority.

8. The method of claim 1, wherein the receiving occurs in at least one of:
real time;
near real time; and
periodically.

9. The method of claim 1, wherein the fleet information for each transport includes at least one of:
an owner of the transport;
a license plate number of the transport;
a vehicle identification number of the transport;
a type of the transport;
a color of the transport;
a manufacturer of the transport;
a year of manufacture of the transport; and
a condition of the transport.

10. A computer readable medium comprising instructions for billing, by a toll rental entity, a fixed fee for unlimited toll usage by a transport, based on at least one of: a transport toll volume and a toll transaction volume.

11. The computer readable medium of claim 10, wherein each transport is at least one of:
an independently owned transport; and
a transport in a fleet.

12. The computer readable medium of claim 10 comprising instructions for receiving, by the toll rental entity, toll usage information and transport information.

13. The computer readable medium of claim 12 comprising instructions for matching, by the toll rental entity, the received information with a transport subscription account.

14. The computer readable medium of claim 13 comprising instructions for billing the fixed fee amount based on the matching.

15. The computer readable medium of claim 13 comprising instructions for billing the fixed fee to at least one of:
a third party entity; and
a toll authority.

16. The computer readable medium of claim 10, wherein the fixed fee may vary based on at least one of:
a location of each of the transports in the fleet;
a number of transports in the fleet;
a length of use of each transport in the fleet;
a time of day of the use of each transport in the fleet;
a day of the use of each transport in the fleet;
a week of the use of each transport in the fleet;
a month of the use of each transport in the fleet;
a year of the use of each transport in the fleet;
a length of a contract for each transport in the fleet;
a toll usage of each of the transports in the fleet;
an age of each of the transports in the fleet;
an emissions rate of each of the transports in the fleet;
an emissions output of each of the transports in the fleet; and
an average mile per gallon rating of each of the transports in the fleet.

17. A system for billing unlimited toll utilization, comprising:
at least one third party entity; and
a toll rental entity communicably coupled to the third party entity;
wherein the toll rental entity bills the third party entity a based on at least one of:
a number of transports in a fleet;
a number of transactions by the transports in the fleet; and
a fixed fee.

18. The system of claim 17, wherein the toll rental entity bills based on an alternating fixed fee.

19. The system of claim 17, wherein, if the toll rental entity bills based on a number of transports in a fleet, the toll rental entity bills based on at least one of:
a mean of a size of a fleet; and
a median of the size of the fleet.

20. The system of claim 17, wherein, if the toll rental entity bills based on a number of transactions by the transports in the fleet, the toll rental entity bills based on a transaction volume.

21. The system of claim 17, wherein the toll rental entity bills the third party entity a based on at least one of:
a second;
a minute;
an hour;
a day;
a week;
a month; and
a year.
